(19) United States
(12) Patent Application Publication
(10) Pub. No.: US 2005/0101340 A1
(43) Pub. Date: May 12, 2005

(54) Wireless power control

(76) Inventor: Donald Paul Archiable, Chagrin Falls, OH (US)

Correspondence Address: BENESCH, FRIEDLANDER, COPLAN & ARONOFF LLP;ATTN: IP DEPARTMENT DOCKET CLERK, 2300 BP TOWER, 200 PUBLIC SQUARE, CLEVELAND, OH, 44114, US

(21) Appl. No.: 10/705,040

(22) Filed: Nov. 10, 2003

(51) Int. Cl. H04Q 7/20

(52) U.S. Cl. 455/522; 455/69

(57) ABSTRACT

Systems, methodologies, media, and other embodiments associated with wireless power control are described. One exemplary system embodiment includes a wireless communication apparatus configured to transmit a wireless computer communication signal at a configurable power level and a power level logic that is configured to automatically determine the configurable power level for the wireless communication apparatus.

### BACKGROUND

Wireless computer communications let computer users “unplug” from their wired network, ostensibly freeing users to roam wherever the wireless world will allow. Devices like laptop computers may now send and receive wireless computer communications over ever expanding ranges so long as users can find and employ “hotspots” (locations where wireless communications are enabled). To increase wireless coverage, wireless communication devices may attempt to send and/or receive radio waves over ever greater distances. But transmitting and receiving radio waves requires power. The well-known inverse quadratic relationship between power and range holds that doubling the range for a wireless communication requires quadrupling the power for that transmission. Frequently, the power for transmitting and receiving radio waves comes from the battery in the wireless device. As the ranges for wireless communication to devices like laptop computers increases, so too do the power requirements for those wireless communications. Thus, while wireless radio communication networks like IEEE 802.11g, IEEE 802.15.1, Wi-Fi, and others liberate users from their network cables, they simultaneously make users slaves to their batteries. Furthermore, the increasing power levels subject wireless users to higher levels of electromagnetic radiation.

Some have attempted to mitigate battery power issues by producing binary on/off wireless systems that shut down a wireless communication system if no communication field is detected. Others have simply made larger batteries. Meanwhile, the full potential of wireless communications for devices like laptop computers remains unfulfilled as conflicting goals of greater range and lower power go unresolved.

### BRIEF DESCRIPTION OF THE DRAWINGS

The accompanying drawings, which are incorporated in and constitute a part of the specification, illustrate various example systems, methods, and so on that illustrate various example embodiments of aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

FIG. 1 illustrates an example wireless power control system.

FIG. 2 illustrates another example wireless power control system.

FIG. 3 illustrates an example wireless power control method.

FIG. 4 illustrates another example wireless power control method.

FIG. 5 illustrates an example wireless power control system.

FIG. 6 illustrates an example computing environment in which example systems and methods illustrated herein can operate.

### DETAILED DESCRIPTION

Wireless-enabled devices like laptop computers may send and receive wireless communications using electromagnetic waves. Conventionally, wireless-enabled devices like laptop computers are configured to transmit to the maximum range associated with a communication method. For example, IEEE 802.11g defines a communication range of up to one hundred and fifty feet. But a wireless-enabled device like a laptop computer may only be three feet from the 802.11g transceiver with which it is communicating. Thus, the wireless-enabled device may be powering a wireless communication circuit and/or apparatus to transmit a signal one hundred and fifty feet when only three feet are needed. Similarly, a cellular phone may power a transmitter up to 4.8 mW to facilitate transmitting to a cell located up to ten miles away. But the cellular phone may only be a city block from the center of the cell. Thus, the example systems and methods described herein describe configuring a wireless-enabled computing device like a laptop computer or a cellular telephone to selectively power their wireless communication circuit(s) and/or apparatus to a lower power level related to the distance a device actually has to transmit, rather than the maximum distance conventionally employed, while retaining a desired quality of service (QOS) for the wireless computer communication. Thus, when the transmission spans a shorter distance, less power will be consumed, which can lead to improved battery life and reduced exposure to electromagnetic radiation.

With emerging concerns about safety and security associated with wireless communications, many have begun to ask not what is the maximum distance a system can transmit, but what is the minimum power that can be used when transmitting? Safer, more secure, greener workspaces may be produced by reducing power. Thus, items like personal, very local area networks (PVLANs) are being designed into items like desks, cubicles, airplane seats, commuter train seats, and so on. These PVLANs create very small wireless-enabled zones (e.g., thirty six inches in a plane) that let users enjoy the benefits of wireless communications (e.g., mobility) while lessening the burdens associated therewith (e.g., excess power consumption, health concerns, security issues).

By way of illustration, a commuter on the Long Island Railroad may want to work on their laptop computer while commuting from Syosset to Penn Station. With a plethora of cellular circuits along the right of way, the commuter may be able to connect a laptop to a cellular network for significant portions of the journey. However, the laptop will be powering its cellular communication circuitry at a power level that disregards the proximity to any actual cell. Thus, battery power will be unnecessarily consumed and users will be exposed to unnecessarily high levels of electromagnetic radiation.

By way of further illustration, some commuter trains may have installed 802.11g and/or 802.11 b “Wi-Fi” hotspots in their commuter cars. Thus, wireless devices within one hundred and fifty feet of the 802.11g device may communicate with the device via 802.11g wireless communications. But the laptop will be powering its 802.11g circuitry at a power level that disregards how far away the 802.11g transceiver is located. The commuter may only be seated ten feet from the 802.11g transceiver but be broadcasting as though the transceiver were at the edge of the maximum range. Once again, battery power will be unnecessarily consumed and users will be exposed to unnecessarily high levels of electromagnetic radiation.

By way of still further illustration, some commuter trains may include PVLAN elements in tables on which a laptop computer can be located. These PVLAN elements may, for example, create a field from the surface of the table upwards for six inches. A laptop sitting on the PVLAN element can communicate through the PVLAN system, but conventionally does so with a wireless circuit designed to be powered to communicate with a relatively distant cell or 802.11g transceiver. Thus, battery power is still unnecessarily consumed and users unnecessarily irradiated. In the PVLAN environment, wireless power control systems and/or methods may reduce the power required for a wireless communication to that required to transmit to the PVLAN element on which the wireless-enabled device like the laptop is sitting, reducing battery power consumption and exposure to electromagnetic radiation.

The above described scenario for a commuter on a commuter train can readily be projected onto other environments like airplanes, classroom desks, office cubicles, conference rooms, hospital rooms, and so on. Thus, battery power consumption and electromagnetic exposure issues may be mitigated, at least in part, by configuring wireless-enabled computing devices like laptop computers and cellular telephones with wireless power controlling systems and methods. Similarly, battery power consumption issues, safety issues, and security issues may be mitigated by employing wireless-enabled devices configured with wireless power controlling systems and methods with PVLAN enabled items like workstation seating, furniture and vehicles. Additionally, computing devices like transceivers may use wireless power control systems and methods to reduce the power at which they transmit. For example, although an 802.11g transceiver may be configured to cover an entire football field sized room, if there is only one wireless communication device user communicating via the transceiver, and that user is only ten feet from the transceiver, then the transceiver may be configured, using example systems and methods described herein, to lower its power output to a computed minimal level that still operates at a desired quality of service. This facilitates reducing power consumption and exposure to electromagnetic radiation. This also facilitates reducing unwanted illicit signal interception.

The following includes definitions of selected terms employed herein. The definitions include various examples and/or forms of components that fall within the scope of a term and that may be used for implementation. The examples are not intended to be limiting. Both singular and plural forms of terms may be within the definitions.

“Computer communication”, as used herein, refers to a communication between two or more computing devices (e.g., computer, personal digital assistant, cellular telephone) and can be, for example, a network transfer, a file transfer, an applet transfer, an email, a hypertext transfer protocol (HTTP) transfer, a message, a packet, and so on. A computer communication can occur across, for example, a wireless system (e.g., IEEE 802.11), an Ethernet system (e.g., IEEE 802.3), a token ring system (e.g., IEEE 802.5), a local area network (LAN), a wide area network (WAN), a global area network (GAN), a point-to-point system, a circuit switching system, a packet switching system, and so on. A wireless computer communication can occur across systems including, but not limited to, an IEEE 802.11 system, an IEEE 802.15 system, and so on.

“Computer-readable medium”, as used herein, refers to a medium that participates in directly or indirectly providing signals, instructions and/or data. A computer-readable medium may take forms, including, but not limited to, non-volatile media, volatile media, and transmission media. Non-volatile media may include, for example, optical or magnetic disks and so on. Volatile media may include, for example, optical or magnetic disks, dynamic memory and the like. Transmission media may include coaxial cables, copper wire, fiber optic cables, and the like. Transmission media can also take the form of electromagnetic radiation, like those generated during radio-wave and infra-red data communications, or take the form of one or more groups of signals. Common forms of a computer-readable medium include, but are not limited to, a floppy disk, a flexible disk, a hard disk, a magnetic tape, other magnetic medium, a CD-ROM, other optical medium, punch cards, paper tape, other physical medium with patterns of holes, a RAM, a ROM, an EPROM, a FLASH-EPROM, or other memory chip or card, a memory stick, a carrier wave/pulse, and other media from which a computer, a processor or other electronic device can read. Signals used to propagate instructions or other software over a network, like the Internet, can be considered a “computer-readable medium.”

“Logic”, as used herein, includes but is not limited to hardware, firmware, software and/or combinations of each to perform a function(s) or an action(s), and/or to cause a function or action from another logic, method, and/or system. For example, based on a desired application or needs, logic may include a software controlled microprocessor, discrete logic like an application specific integrated circuit (ASIC), a programmed logic device, a memory device containing instructions, or the like. Logic may include one or more gates, combinations of gates, or other circuit components. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

An “operable connection”, or a connection by which entities are “operably connected”, is one in which signals, physical communication flow, and/or logical communication flow may be sent and/or received. Typically, an operable connection includes a physical interface, an electrical interface, and/or a data interface, but it is to be noted that an operable connection may include differing combinations of these or other types of connections sufficient to allow operable control. For example, two entities can be operably connected by being able to communicate signals to each other directly or through one or more intermediate entities like a processor, operating system, a logic device, software, or other entity. Logical and/or physical communication channels can be used to create an operable connection.

“Signal”, as used herein, includes but is not limited to one or more electrical or optical signals, analog or digital signals, data, one or more computer or processor instructions, messages, a bit or bit stream, or other means that can be received, transmitted and/or detected.

“Software”, as used herein, includes but is not limited to, one or more computer or processor instructions that can be read, interpreted, compiled, and/or executed and that cause a computer, processor, or other electronic device to perform functions, actions and/or behave in a desired manner. The instructions may be embodied in various forms like routines, algorithms, modules, methods, threads, and/or programs including separate applications or code from dynamically linked libraries. Software may also be implemented in a variety of executable and/or loadable forms including, but not limited to, a stand-alone program, a function call (local and/or remote), a servelet, an applet, instructions stored in a memory, part of an operating system or other types of executable instructions. It will be appreciated by one of ordinary skill in the art that the form of software may be dependent on, for example, requirements of a desired application, the environment in which it runs, and/or the desires of a designer/programmer or the like. It will also be appreciated that computer-readable and/or executable instructions can be located in one logic and/or distributed between two or more communicating, co-operating, and/or parallel processing logics and thus can be loaded and/or executed in serial, parallel, massively parallel and other manners.

Suitable software for implementing the various components of the example systems and methods described herein include programming languages and tools like Java, Pascal, C#, C++, C, CGI, Perl, SQL, APIs, SDKs, assembly, firmware, microcode, and/or other languages and tools. Software, whether an entire system or a component of a system, may be embodied as an article of manufacture and maintained as part of a computer-readable medium as defined previously. Another form of the software may include signals that transmit program code of the software to a recipient over a network or other communication medium.

“User”, as used herein, includes but is not limited to one or more persons, software, computers or other devices, or combinations of these.

Some portions of the detailed descriptions that follow are presented in terms of algorithms and symbolic representations of operations on data bits within a memory. These algorithmic descriptions and representations are the means used by those skilled in the art to convey the substance of their work to others. An algorithm is here, and generally, conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic and the like.

It has proven convenient at times, principally for reasons of common usage, to refer to these signals as bits, values, elements, symbols, characters, terms, numbers, or the like. It should be borne in mind, however, that these and similar terms are to be associated with the appropriate physical quantities and are merely convenient labels applied to these quantities. Unless specifically stated otherwise, it is appreciated that throughout the description, terms like processing, computing, calculating, determining, displaying, or the like, refer to actions and processes of a computer system, logic, processor, or similar electronic device that manipulates and transforms data represented as physical (electronic) quantities.

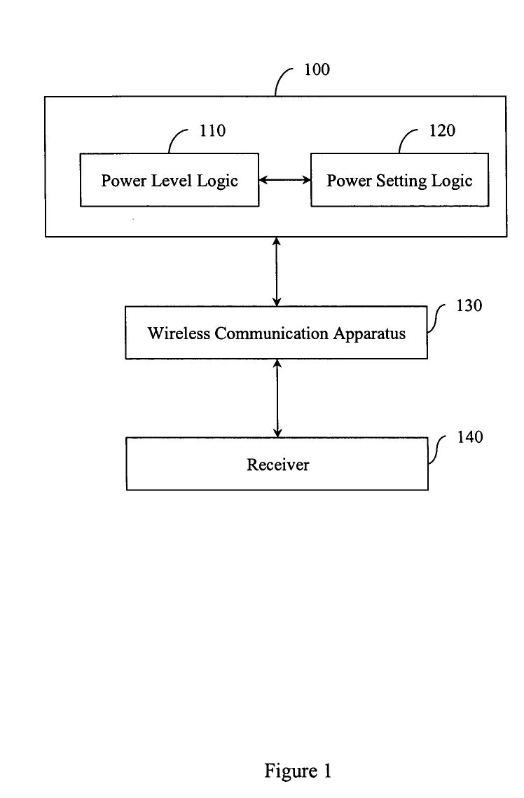

FIG. 1 illustrates an example wireless power control system 100. The power control system 100 may include a power level logic 110 that may be configured to automatically determine a power level at which a wireless communication apparatus 130 will transmit a wireless computer communication. The wireless communication apparatus 130 may be, for example, a transmitter and/or a transceiver configured to broadcast IEEE 802.11, IEEE 802.15.1 messages, and the like. Thus, the system 100 may be located, for example, in a laptop computer that communicates wireless computer communications with an IEEE 802.11g repeater. The power level logic 110 may determine the power level based, at least in part, on the distance between the wireless communication apparatus 130 and the intended target (e.g., receiver 140) of the wireless computer communication. In a first example, the wireless communication apparatus 130 may be located at a first distance from the receiver 140 and thus a first power level for transmitting is determined. In a second example, the wireless communication apparatus 130 may be located at a second closer distance from the receiver 140 and thus a second lower power level for transmitting is determined. Determining a power level based on the distance between the wireless communication apparatus 130 and the receiver 140 facilitates, for example, conserving battery power, reducing power consumption, reducing user exposure to electromagnetic waves associated with wireless communications, and increasing computer security. While distance is described, it is to be appreciated that other factors (e.g., intervening walls) may influence the power required to maintain a quality of service between the wireless communication apparatus 130 and the receiver 140.

In one example, the power level logic 110 may be configured to provide test power levels at which the wireless communication apparatus 130 will transmit one or more power level determination messages to the receiver 140. The various power levels may be pre-determined and/or may be calculated on-the-fly based on the presence or absence of a response to a test message and/or quality data associated with the response. By way of illustration, the power level logic 110 may provide ten pre-calculated test power levels at which the wireless communication apparatus 130 transmits power level determination test messages. By way of further illustration, the power level logic 110 may provide a first test power level and then calculate one or more subsequent test power levels based on the response to the first test power level and/or a subsequent test power level.

In another example, the power level logic 110 may be configured to analyze responses to the power level determination messages to determine the power level. For example, a response message may indicate that a test message was received with a first quality of service that indicates that a lower power level can be employed. Thus, a power level determination message may be sent at a lower test power level and the response, if any, analyzed by the power level logic 110. Thus, a step-down switching method may be implemented by the power level logic 110 to facilitate identifying a reduced power level at which a desired quality of service can be maintained. The step-down switching method may include, for example, testing wireless communication at a first power level, and if that test is successful, stepping down to a next lower level and repeatedly stepping down to lower power levels until the reduced power level that maintains the desired quality of service is identified.

The system 100 may also include a power setting logic 120 configured to be operably connected to the power level logic 110 and the wireless communication apparatus 130. The power setting logic 120 may be configured to establish the power level at which the wireless communication apparatus 130 will transmit the wireless computer communication to the receiver 140. In one example, the power setting logic 120 may be configured to establish the power level at which the wireless communication apparatus 130 will transmit the wireless computer communication in response to the power level logic 110 analyzing responses and determining a power level. In another example, the power level logic 110 may be configured to determine a minimal power level at which a desired quality of service can be maintained. Thus, the power setting logic 120 may be configured to establish the minimal power level as the power level at which the wireless communication apparatus 130 will transmit the wireless computer communication.

The power setting logic 120 may establish the power level at which the wireless communication apparatus 130 will transmit the wireless computer communication by various methods. For example, the power setting logic 120 may send a signal to the wireless communication apparatus 130 and/or the power setting logic 120 by controlling properties like voltage, current, and/or resistance associated with the wireless communication apparatus 130.

While the power level logic 110, the power setting logic 120, and the wireless communication apparatus 130 are illustrated as separate entities, it is to be appreciated that the power level logic 110, the power setting logic 120, and the wireless communication apparatus 130 could be integrated into a smaller number of entities and/or distributed between a greater number of entities. Furthermore, the power level logic 110, the power setting logic 120, and the wireless communication apparatus 130 may be located in computing devices including, but not limited to, a computer, a personal digital assistant, and a cellular telephone.

As described above, the wireless communication apparatus 130 can be configured to transmit a variety of signals at various spectrum frequencies. For example, the wireless communication apparatus 130 may transmit signals for communication types including, but not limited to, a global system for mobile communications (GSM) communication, an IEEE 802.11 wireless communication, and an IEEE 802.15.1 wireless communication.

The power level logic 110 may be configured to determine the power level for the wireless communication apparatus 130 at, for example, the time when a wireless-enabled computing device (e.g., laptop computer, personal digital assistant, notebook computer) discovers a wireless network. However, since such devices are by nature mobile, the power level logic 110 may additionally and/or alternatively be configured to periodically redetermine the power level. Similarly, the power setting logic 120 may be configured to periodically reestablish the power level.

Thus, to illustrate how the system 100 might function, consider a situation where a user carries a laptop computer into a room that has an 802.11g transceiver. The laptop discovers the wireless communication network and then determines the minimal power level at which the laptop can transmit to the 802.11g transceiver. If the distance is less than the maximum one hundred and fifty feet specified by 802.11g, then the laptop may power down its wireless communication circuitry to a lower power level than required to transmit one hundred and fifty feet. Thus, the laptop may consume less power, extend the life of the battery charge for longer device utilization, and expose the user of the laptop to lower powered electromagnetic waves. On the security side, with the laptop configured to transmit the shortest possible distance to maintain a desired quality of service to the 802.11 g transceiver, a sphere of confidence is produced. The sphere of confidence is the spatial area in which the electromagnetic waves generated by the laptop are available, and outside of which the waves are not available. While a minimal distance or shortest possible distance is described, it is to be appreciated that a computing device like a laptop may be configured to transmit at a distance different from the shortest possible distance to the 802.11g transceiver.

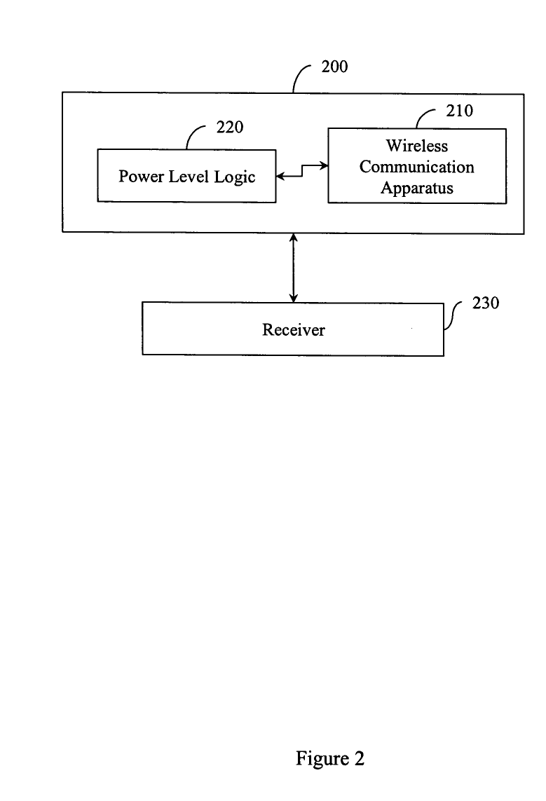

FIG. 2 illustrates an example wireless power control system 200. The system 200 may include a wireless communication apparatus 210 configured to transmit a wireless computer communication signal at a configurable power level that is related to the distance between the wireless communication apparatus 210 and a receiver 230 of the wireless computer communication signal. The wireless computer communication signal may be, for example, an IEEE 802.11 signal, an IEEE 802.15.1 signal, and the like.

The system 200 may also include a power level logic 220 operably connectable to the wireless communication apparatus 210. The power level logic 220 may be configured to automatically determine the configurable power level for the wireless communication apparatus 210. The power level can be selected to facilitate maintaining a desired quality of service for the wireless computer communication signal while reducing power consumption by the wireless communication apparatus 210. Thus, the system 200 may facilitate reducing power consumption, extending battery life in mobile computing devices, exposing mobile computing device users to less electromagnetic radiation, and increasing security.

In one example, the power level logic 220 can be configured to determine the configurable power level by analyzing wireless communications between the wireless communication apparatus 210 and a receiver 230. For example, while a wireless-enabled computing device like a personal digital assistant that is configured with system 200 is performing Bluetooth (IEEE 802.15.1) discovery with a receiver 230, the power level logic 220 may analyze a set of communications between the wireless communication apparatus 210 and the receiver 230 to determine a reduced power level at which a desired quality of service can be maintained. Thus, after transmitting a set of test messages at various power levels to determine a reduced power, rather than the Bluetooth configured personal digital assistant broadcasting messages that can travel up to thirty five feet, which requires a first, full power, the Bluetooth configured personal digital assistant may broadcast messages that can travel only eight feet, which requires a second, less than full power. In one example, the power level logic 220 may be configured to perform a step-down method that progresses down through multiple power levels.

The wireless communication apparatus 210 and the power level logic 220 may be located, for example, in computing devices including, but not limited to, a computer, a personal digital assistant, and a cellular telephone.

While system 100 and system 200 are described in connection with portable computing devices like laptop computers and personal digital assistants, it is to be appreciated that other computing devices like desktop systems may be configured with such systems. Similarly, computing devices like 802.11g transceivers and repeaters, 802.15.1 transceivers and repeaters, GSM transceivers and repeaters, and so on may be configured to determine and establish reduced power levels. While these devices may typically not be battery powered, the example wireless power control systems and methods may still facilitate reducing power consumption, reducing electromagnetic radiation exposure, and increasing security.

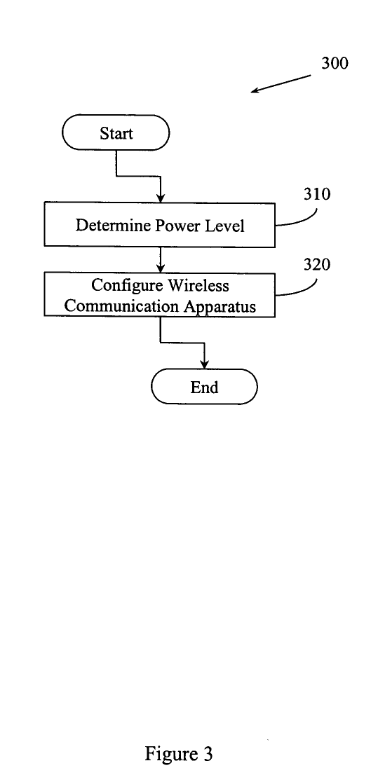

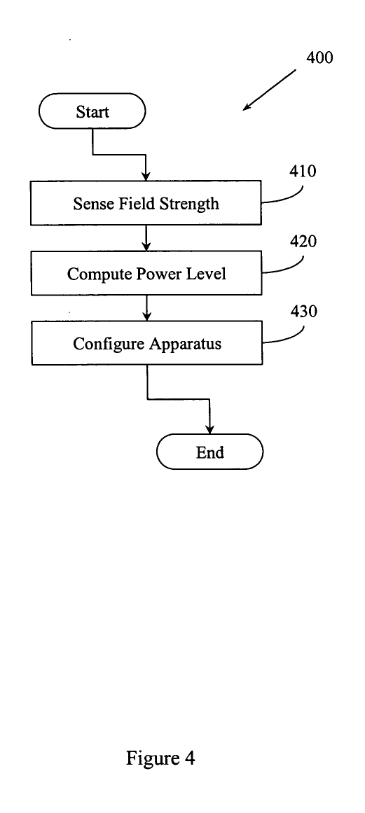

Example methods may be better appreciated with reference to the flow diagrams of FIGS. 3 and 4. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Furthermore, additional and/or alternative methodologies can employ additional, not illustrated blocks.

In the flow diagrams, blocks denote “processing blocks” that may be implemented with logic. A flow diagram does not depict syntax for any particular programming language, methodology, or style (e.g., procedural, object-oriented). Rather, a flow diagram illustrates functional information one skilled in the art may employ to develop logic to perform the illustrated processing. It will be appreciated that in some examples, program elements like temporary variables, routine loops, and so on are not shown. It will be further appreciated that electronic and software applications may involve dynamic and flexible processes so that the illustrated blocks can be performed in other sequences that are different from those shown and/or that blocks may be combined or separated into multiple components. It will be appreciated that the processes may be implemented using various programming approaches like machine language, procedural, object oriented and/or artificial intelligence techniques.

FIG. 3 illustrates an example wireless power control method 300. The method 300 may include, at 310, determining a power level at which a wireless communication apparatus associated with a computing device will transmit, where the power level is based, at least in part, on a distance between the wireless communication apparatus (e.g., Wi-Fi card in a laptop) and a receiver (e.g., Wi-Fi router). The computing device may be, for example, a laptop computer, a personal digital assistant, a cellular telephone, an 802.11 transceiver and/or repeater, an 802.15.1 transceiver and/or repeater, and so on.

In one example, determining the power level may include repetitively establishing a test power level at which a test message will be transmitted from the wireless communication apparatus to the receiver and then transmitting the test message at that test power level. There may or may not be a response to the test message depending, for example, on whether the test power level was sufficient to transmit the message to the receiver. Thus, determining the power level can also include determining whether there was a response to the test message and if so, evaluating the response. The response may, for example, include data concerning the strength of signal and/or quality of service associated with the test message broadcast at the test power level. Thus, determining the power level may include calculating the power level based, at least in part, on whether there was a response and an evaluation of the response.

In another example, determining the power may include calculating a distance between the wireless communication apparatus and the receiver and computing the power level based, at least in part, on the distance. For example, the wireless communication apparatus may have available global positioning system data by which it can compute its location. Similarly, the wireless communication apparatus may acquire global positioning system data concerning a receiver by which it can compute the location of the receiver. Thus, with both positions computed, the distance between the locations can be computed. While global positioning system data is described, it is to be appreciated that other methods for determining absolute and/or relative location can be employed.

In another example, determining the power level can include identifying a communication protocol by which the wireless communication apparatus will communicate and computing the power level based, at least in part, on the communication protocol. For example, a wireless-enabled computing device like a laptop may include more than one apparatus for wireless communications. By way of illustration, a laptop may include a Wi-Fi apparatus and a Bluetooth apparatus that consume different amounts of power. If both a Wi-Fi connection and a Bluetooth connection are available, then the power level may be determined by comparing the relative power consumption of communicating via the two apparatus.

In still another example, computing the power level may include determining whether the wireless communication apparatus is located in a PVLAN zone. For example, a discovery message may be broadcast that facilitates identifying whether the wireless communication device can communicate via a PVLAN. By way of illustration, when a traveler places their laptop computer on a table in an airport VIP lounge that is PVLAN enabled, the laptop computer may discover that it can communicate using the minimal power requirements of the PVLAN system. Thus, power consumption may be reduced, battery life may be prolonged, the traveler and those around the traveler may be exposed to less electromagnetic radiation. Subsequently, when the traveler flips a PVLAN-enabled table out from a first class airplane seat, the traveler's laptop may communicate with the PVLAN using low powered wireless computer communications. Thus, the PVLAN traveler may still have battery power after flying New York to Los Angeles, while the conventional wireless user ran out of battery power somewhere over the Midwest.

The method 300 may also include, at 320, configuring the wireless communication apparatus to transmit at the determined power level. Since wireless-enabled devices tend to be mobile (e.g., personal digital assistant), the initial power level determination may lose accuracy as the wireless-enabled device moves around. Thus, the method 300 may also include periodically redetermining the power level and/or periodically reconfiguring the wireless communication apparatus.

While FIG. 3 illustrates various actions occurring in serial, it is to be appreciated that various actions illustrated in FIG. 3 could occur substantially in parallel. By way of illustration, a first process could substantially constantly and/or periodically determine a suitable power level while a second process could substantially constantly and/or periodically reconfigure a wireless communication apparatus. While two processes are described, it is to be appreciated that a greater and/or lesser number of processes could be employed and that lightweight processes, regular processes, threads, and other approaches could be employed.

Methodologies may be implemented as processor executable instructions and/or operations stored on a computer-readable medium. Thus, in one example, a computer-readable medium may store processor executable instructions operable to perform a method that includes determining a power level at which a wireless communication apparatus associated with a computing device will transmit and configuring the wireless communication apparatus to transmit at the determined power level. While the above method is described being stored on a computer-readable medium, it is to be appreciated that other example methods described herein can also be stored on a computer-readable medium.

FIG. 4 illustrates another example wireless power control method 400. The method 400 may include, at 410, sensing a strength of an electromagnetic field produced by a wireless communication device with which a wireless-enabled computing device will communicate. Sensing the field may include, for example, taking a reading from a magneto-resistive device and/or other field sensor.

The method 400 may also include, at 420, computing a transmission power level for the wireless-enabled computing device based, at least in part, on the electromagnetic field strength and, at 430, configuring the wireless-enabled computing device according to the computed transmission power level. Computing a transmission power level may include sending and/or receiving messages transmitted at various power levels to determine a suitable power level. Thus, the method 400 may also include, sending a test message from the wireless-enabled computing device to the wireless communication device at the computed transmission power level and selectively recomputing the transmission power level based on a response to the test message. By way of illustration, a notebook computer may be configured with an IEEE 802.11a card. When a user sits down in a coffee shop, the notebook computer may attempt to discover whether there is an IEEE 802.11a communication link available. If the notebook computer discovers a link, then it may take the additional step of determining a suitable, hopefully less than maximum, power level that can be employed to transmit to the communication device (e.g., router, repeater) supplying the link. Thus, the notebook computer may be able to run longer and be exposed to less electromagnetic radiation while the user sips their latte, chews their biscotti, and reads the Sunday Times.

While FIG. 4 illustrates various actions occurring in serial, it is to be appreciated that various actions illustrated in FIG. 4 could occur substantially in parallel. By way of illustration, a first process could initially, periodically, and/or substantially simultaneously sense a field strength produced by a wireless communication device (e.g., router). Similarly, a second process could compute a power level required to transmit wireless messages to the wireless communication device with a desired quality of service, while a third process could configure a computing device and/or its wireless communication apparatus to operate at the power level computed by the second process. While three processes are described, it is to be appreciated that a greater and/or lesser number of processes could be employed and that lightweight processes, regular processes, threads, and other approaches could be employed.

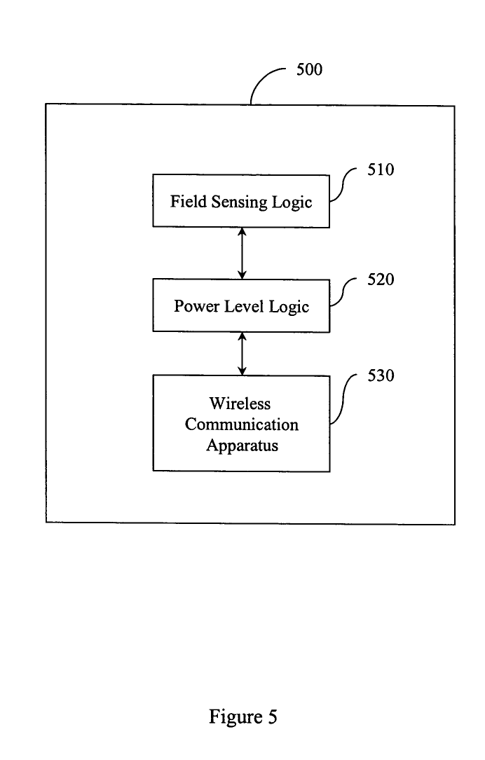

FIG. 5 illustrates an example wireless power control system 500. The system 500 may include, for example, a wireless communication apparatus 530 like a Wi-Fi card or a Bluetooth card. The system 500 may also include a field sensing logic 510 configured to sense the strength of a wireless communication field in which the wireless communication apparatus is located. The field may be created by, for example, a PVLAN element, an IEEE 802.11 device, an IEEE 802.15.1 device, and so on. Thus, the field sensing logic 510 may be configured to distinguish field strengths created by different types of devices. The system 500 may also include a power level logic 520 operably connectable to the wireless communication apparatus 530 and the field sensing logic 510. The power level logic 520 may be configured to control a power level at which the wireless communication apparatus 530 will transmit. The power level may be based, at least in part, on the strength of the wireless communication field sensed by the field sensing logic 510. Thus, the system 500 facilitates configuring a wireless-enabled computing device like a laptop computer to transmit wireless computer communication messages at lower power levels than is conventional when the laptop computer is located closer to a wireless network device than the maximum distance specified in a protocol.

The field sensing logic 510 and the power level logic 520, embodied as software, firmware, hardware and/or a combination thereof may function as means for determining a power level at which a wireless communication device will transmit to facilitate reducing a power consumption while maintaining a desired quality of service. Similarly, the wireless communication apparatus 530 (e.g., Wi-Fi card, Bluetooth card, 802.11g card), may function as means for transmitting a wireless communication at the determined power level.

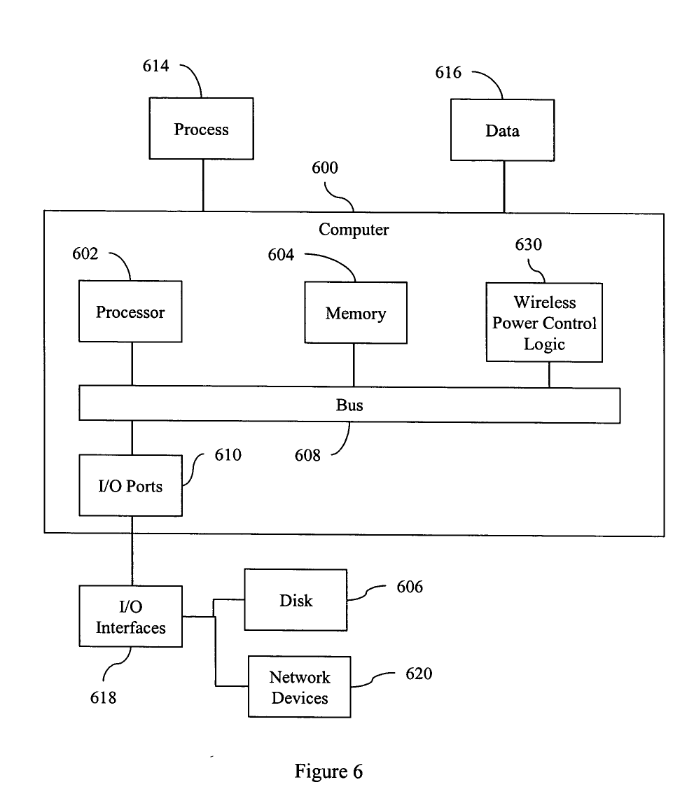

FIG. 6 illustrates a computer 600 that includes a processor 602, a memory 604, and input/output ports 610 operably connected by a bus 608. In one example, the computer 600 may include a wireless power control logic 630 configured to facilitate reducing power consumption by wireless communication devices while maintaining a desired quality of service for wireless computer communications. Reducing power consumption can increase battery life for computer 600 while reducing exposure to electromagnetic radiation. While the wireless power control logic 630 is illustrated being connected to bus 608, it is to be appreciated that the wireless power control logic 630 may be located in other locations and connected to other components like i/o ports 610, i/o interfaces 618, network devices 620, and so on. The wireless power control logic 630 can be configured to perform the example methods described herein and/or can be configured to perform the functions of the field sensing logic 510 (FIG. 5), power level logic 520 (FIG. 5), power level logic 220 (FIG. 2), power setting logic 120 (FIG. 1), and/or power level logic 110 (FIG. 1).

The processor 602 can be a variety of various processors including dual microprocessor and other multi-processor architectures. The memory 604 can include volatile memory and/or non-volatile memory. The non-volatile memory can include, but is not limited to, ROM, PROM, EPROM, EEPROM, and the like. Volatile memory can include, for example, RAM, synchronous RAM (SRAM), dynamic RAM (DRAM), synchronous DRAM (SDRAM), double data rate SDRAM (DDR SDRAM), and direct RAM bus RAM (DRRAM).

A disk 606 may be operably connected to the computer 600 via, for example, an input/output interface (e.g., card, device) 618 and an input/output port 610. The disk 606 can include, but is not limited to, devices like a magnetic disk drive, a solid state disk drive, a floppy disk drive, a tape drive, a Zip drive, a flash memory card, and/or a memory stick. Furthermore, the disk 606 can include optical drives like a CD-ROM, a CD recordable drive (CD-R drive), a CD rewriteable drive (CD-RW drive), and/or a digital video ROM drive (DVD ROM). The memory 604 can store processes 614 and/or data 616, for example. The disk 606 and/or memory 604 can store an operating system that controls and allocates resources of the computer 600.

The bus 608 can be a single internal bus interconnect architecture and/or other bus or mesh architectures. The bus 608 can be of a variety of types including, but not limited to, a memory bus or memory controller, a peripheral bus or external bus, a crossbar switch, and/or a local bus. The local bus can be of varieties including, but not limited to, an industrial standard architecture (ISA) bus, a microchannel architecture (MSA) bus, an extended ISA (EISA) bus, a peripheral component interconnect (PCI) bus, a universal serial (USB) bus, and a small computer systems interface (SCSI) bus.

The computer 600 may interact with input/output devices via i/o interfaces 618 and input/output ports 610. Input/output devices can include, but are not limited to, a keyboard, a microphone, a pointing and selection device, an audio/visual video conference apparatus, a musical instrument digital interface (MIDI), cameras, video cards, displays, disk 606, network devices 620, and the like. The input/output ports 610 can include but are not limited to, serial ports, parallel ports, and USB ports.

The computer 600 can operate in a network environment and thus may be connected to network devices 620 via the i/o devices 618, and/or the i/o ports 610. Through the network devices 620, the computer 600 may interact with a network. Through the network, the computer 600 may be logically connected to remote computers. The networks with which the computer 600 may interact include, but are not limited to, a local area network (LAN), a wide area network (WAN), and other networks. The network devices 620 can connect to LAN technologies including, but not limited to, fiber distributed data interface (FDDI), copper distributed data interface (CDDI), Ethernet (IEEE 802.3), token ring (IEEE 802.6), wireless computer communication (IEEE 802.11), Bluetooth (IEEE 802.15.1), serial data digital interfaces (SDDI), serial digital interfaces (SDI), and the like. Similarly, the network devices 620 can connect to WAN technologies including, but not limited to, point to point links, circuit switching networks like integrated services digital networks (ISDN), packet switching networks, and digital subscriber lines (DSL).

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicants' general inventive concept. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modem Legal Usage 624 (2d. Ed. 1995).

1. A system, comprising:
a power level logic configured to automatically determine a power level at which a wireless communication apparatus will transmit a wireless computer communication, where the power level depends, at least in part, on a distance between the wireless communication apparatus and a receiver of the wireless computer communication; and
a power setting logic configured to be operably connected to the power level logic and the wireless communication apparatus, the power setting logic configured to establish the power level at which the wireless communication apparatus will transmit the wireless computer communication.

2. The system of claim 1, where the power level logic may be configured to provide one or more test power levels at which the wireless communication apparatus will transmit one or more power level determination messages.

3. The system of claim 2, where the power level logic may be configured to analyze one or more responses to the one or more power level determination messages to determine the power level.

4. The system of claim 3, where the power level logic may be configured to determine a minimal power level at which a desired quality of service can be maintained.

5. The system of claim 4, where the power setting logic may be configured to establish the minimal power level as the power level at which the wireless communication apparatus will transmit the wireless computer communication.

6. The system of claim 3, where the power setting logic may be configured to establish the power level at which the wireless communication apparatus will transmit the wireless computer communication in response to the power level determined by analyzing the one or more responses.

7. The system of claim 1, where the power setting logic may be configured to establish the power level at which the wireless communication apparatus will transmit the wireless computer communication by sending a signal to the wireless communication apparatus.

8. The system of claim 1, where the power setting logic may be configured to establish the power level at which the wireless communication apparatus will transmit the wireless computer communication by controlling one or more of, a voltage, a current, and a resistance associated with the wireless communication apparatus.

9. The system of claim 1, where the power level logic, the power setting logic, and the wireless communication apparatus are located in a computer.

10. The system of claim 1, where the power level logic, the power setting logic, and the wireless communication apparatus are located in a personal digital assistant.

11. The system of claim 1, where the power level logic, the power setting logic, and the wireless communication apparatus are located in a cellular telephone.

12. The system of claim 1, where the wireless communication apparatus may be configured to transmit a global system for mobile communications (GSM) communication.

13. The system of claim 1, where the wireless communication apparatus may be configured to transmit an IEEE 802.11 wireless computer communication.

14. The system of claim 1, where the wireless communication apparatus may be configured to transmit an IEEE 802.11g wireless computer communication.

15. The system of claim 1, where the wireless communication apparatus may be configured to transmit an IEEE 802.15.1 wireless computer communication.

16. The system of claim 1, where the power level logic may be configured to periodically redetermine the power level.

17. The system of claim 16, where the power setting logic may be configured to periodically reestablish the power level.

18. The system of claim 1, where the power level logic is configured to perform a step-down method for identifying a reduced power level at which a desired quality of service can be maintained.

19. A system, comprising:
a power level logic configured to automatically determine a power level at which a wireless communication apparatus will transmit a wireless computer communication, where the power level depends, at least in part, on a distance between the wireless communication apparatus and a receiver of the wireless computer communication; and
a power setting logic configured to be operably connected to the power level logic and the wireless communication apparatus, the power setting logic configured to establish the power level at which the wireless communication apparatus will transmit the wireless computer communication;
where the power level logic is configured to provide one or more test power levels at which the wireless communication apparatus will transmit one or more power level determination messages, to receive one or more responses to the one or more power level determination messages, and to analyze the one or more responses to determine a minimal power level at which a desired quality of service can be maintained; and
where the power setting logic is configured to establish the minimal power level as the power level at which the wireless communication apparatus will transmit the wireless computer communication, and where the power setting logic establishes the power level at which the wireless communication apparatus will transmit the wireless computer communication by one or more of, sending a signal to the wireless communication apparatus, and controlling one or more of, a voltage, a current, and a resistance associated with the wireless communication apparatus.

20. The system of claim 19, where the power level logic, the power setting logic, and the wireless communication apparatus are located in one of, a computer, a personal digital assistant, and a cellular telephone.

21. The system of claim 19, where the wireless communication apparatus may be configured to transmit one or more of, an IEEE 802.11 communication, and an IEEE 802.15.1 communication.

22. A system, comprising:
a wireless communication apparatus configured to transmit a wireless computer communication signal at a configurable power level that is related to the distance between the wireless communication apparatus and a receiver of the wireless computer communication signal; and
a power level logic operably connectable to the wireless communication apparatus, the power level logic configured to automatically determine the configurable power level for the wireless communication apparatus, where the power level maintains a desired quality of service for the wireless computer communication signal and facilitates reducing a power consumption by the wireless communication apparatus.

23. The system of claim 22, where the power level logic may be configured to determine the configurable power level by analyzing one or more wireless computer communications between the wireless communication apparatus and the receiver.

24. The system of claim 23, where the wireless computer communication signal is one or more of, an IEEE 802.11 signal, and an IEEE 802.15.1 signal.

25. The system of claim 23, where the configurable power level is the minimum power level that maintains the desired quality of service.

26. The system of claim 22, where the wireless communication apparatus and the power level logic are located in one of, a computer, a personal digital assistant, and a cellular telephone.

27. The system of claim 21, where the power level logic is configured to determine a distance between the wireless communication apparatus and the receiver of the wireless computer communication by analyzing one or more global positioning system (GPS) data.

28. A method, comprising:
determining a power level at which a wireless communication apparatus associated with a computing device will transmit, where the power level is based, at least in part, on a distance between the wireless communication apparatus and a receiver; and
configuring the wireless communication apparatus to transmit at the determined power level.

29. The method of claim 28, where determining the power level includes:
one or more times:
establishing a test power level at which a test message will be transmitted from the wireless communication apparatus to the receiver;
transmitting the test message at the test power level;
making a response determination concerning whether a response to the test message was received; and
if a response was received, making a response evaluation concerning the response; and
calculating the power level based, at least in part, on the response determination and the response evaluation.

30. The method of claim 28, where determining the power level includes:
calculating a distance between the wireless communication apparatus and the receiver; and
computing the power level based, at least in part, on the distance.

31. The method of claim 28, where determining the power level includes:
identifying a communication protocol by which the wireless communication apparatus will communicate; and
computing the power level based, at least in part, on the communication protocol.

32. The method of claim 28, where determining the power level includes:
computing the power level based, at least in part, on whether the wireless communication apparatus is located in a PVLAN zone.

33. The method of claim 28, including periodically redetermining the power level.

34. The method of claim 28, where the computing device is one of, a computer, and a personal digital assistant.

35. A computer-readable medium storing processor executable instructions operable to perform a method, the method comprising:
determining a power level at which a wireless communication apparatus associated with a computing device will transmit, where the power level is based, at least in part, on a distance between the wireless communication apparatus and a receiver; and
configuring the wireless communication apparatus to transmit at the determined power level.

36. The computer-readable medium of claim 35, where determining the power level includes:
one or more times:
establishing a test power level at which a test message will be transmitted from the wireless communication apparatus to the receiver;
transmitting the test message at the test power level;
making a response determination concerning whether a response to the test message was received; and
if a response was received, making a response evaluation concerning the response; and
calculating the power level based, at least in part, on the response determination and the response evaluation.

37. A method, comprising:
sensing a strength of an electromagnetic field produced by a wireless communication device with which a wireless-enabled computing device will communicate;
computing a transmission power level for the wireless-enabled computing device based, at least in part, on the electromagnetic field strength; and
configuring the wireless-enabled computing device according to the computed transmission power level.

38. The method of claim 37, including:
sending a test message from the wireless-enabled computing device to the wireless communication device at the computed transmission power level; and
selectively recomputing the transmission power level based on a response to the test message.

39. A system, comprising:
a wireless communication apparatus;
a field sensing logic configured to sense the strength of a wireless communication field in which the wireless communication apparatus is located; and
a power level logic operably connectable to the wireless communication apparatus and the field sensing logic, the power level logic configured to control a power level at which the wireless communication apparatus will transmit based, at least in part, on the strength of the wireless communication field sensed by the field sensing logic.

40. A system, comprising:
means for determining a power level at which a wireless communication device will transmit to facilitate reducing a power consumption while maintaining a desired quality of service; and
means for transmitting a wireless computer communication at the determined power level.

41. A wireless-enabled computing device, comprising:
a wireless communication apparatus;
a global positioning system apparatus configured to compute a location for the wireless-enabled computing device; and
a power level logic operably connectable to the wireless communication apparatus and the global positioning system apparatus, the power level logic configured to control a power level at which the wireless communication apparatus will transmit based, at least in part, on the location of the wireless-enabled communication device.

42. A wireless-enabled device, comprising:
a wireless communication apparatus;
a global positioning system apparatus configured to compute a location for the wireless-enabled device; and
a power level logic operably connectable to the wireless communication apparatus and the global positioning system apparatus, the power level logic configured to control a power level at which the wireless communication apparatus will transmit based, at least in part, on the location of the wireless-enabled device.
